(19) United States
(12) Patent Application Publication
(10) Pub. No.: US 2012/0140269 A1
(43) Pub. Date: Jun. 7, 2012

(54) INFORMATION PROCESSING DEVICE, INFORMATION PROCESSING METHOD, AND RECORDING MEDIUM

(76) Inventor: Hiroto KOBAYASHI, Saitama (JP)

(21) Appl. No.: 13/297,468

(22) Filed: Nov. 16, 2011

(30) Foreign Application Priority Data
Dec. 1, 2010 (JP) 2010-268840

(51) Int. Cl. G06F 3/12

(52) U.S. Cl. 358/1.15

(57) ABSTRACT

An information processing device including: a generation unit that generates a first drawing page on which print data created by an application is drawn and a second drawing page on which drawing data designated to be added onto the print data is drawn; a transmitting unit that sends the second drawing page subsequent to the first drawing page; a receiving unit that receives a command to start each of the first and the second drawing pages and a command to end each of the first and the second drawing pages; and an output control unit that outputs in a manner that the second drawing page is added onto the first drawing page by not executing the command to end the first drawing page and the command to start the second drawing page.

### CROSS-REFERENCE TO RELATED APPLICATIONS

The present application claims priority to and incorporates by reference the entire contents of Japanese Patent Application No. 2010-268840 filed in Japan on Dec. 1, 2010.

### BACKGROUND OF THE INVENTION

1. Field of the Invention

The present invention relates to a print program, an information processing device, and a recording medium.

2. Description of the Related Art

In the related art, printer drivers have been known to have a stamp function (watermark function) of adding character data, graphic data, and image data to data printed by an application.

For example, Japanese Patent Application Laid-open No. 2002-333959 discloses a print system which improves printing properties and convenience when adding a stamp to print data generated by an application. The print system of Japanese Patent Application Laid-open No. 2002-333959 generates drawing data of a stamp or the like on behalf of an application, upon receiving the drawing data to be added and a print start event, from a printer driver. Then, the print system adds the generated drawing data to a spool file, extracts pages of print data and pages of drawing data from the spool file using a print processor, and combines the print data with the drawing data.

However, in the method of Japanese Patent Application Laid-open No. 2002-333959, when the print processor adds the drawing data of a stamp or the like to print data created by an application, printing the drawing data on the front side of the print data created by the application is not allowed.

There is a need of an information processing device, information processing method, and a recording medium capable of printing a drawing data onto a print data generated by an application.

### SUMMARY OF THE INVENTION

It is an object of the present invention to at least partially solve the problems in the conventional technology.

An information processing device including: a generation unit that generates a first drawing page on which print data created by an application is drawn and a second drawing page on which drawing data designated to be added onto the print data is drawn; a transmitting unit that sends the second drawing page subsequent to the first drawing page; a receiving unit that receives a command to start each of the first and the second drawing pages and a command to end each of the first and the second drawing pages; and an output control unit that outputs in a manner that the second drawing page is added onto the first drawing page by not executing the command to end the first drawing page and the command to start the second drawing page.

An information processing method including: generating, by a generation unit, a first drawing page on which print data created by an application is drawn and a second drawing page on which drawing data designated to be added onto the print data is drawn; sending, by a transmitting unit, the second drawing page subsequent to the first drawing page; receiving, by a receiving unit, a command to start each of the first and the second drawing pages and a command to end each of the first and the second drawing pages; and outputting, by an output control unit, in a manner that the second drawing page is added onto the first drawing page by not executing the command to end the first drawing page and the command to start the second drawing page.

A non-transitory computer-readable recording medium having a program including instructions for causing a computer to function as: generating, by a generation unit, a first drawing page on which print data created by an application is drawn and a second drawing page on which drawing data designated to be added onto the print data is drawn; sending, by a transmitting unit, the second drawing page subsequent to the first drawing page; receiving, by a receiving unit, a command to start each of the first and the second drawing pages and a command to end each of the first and the second drawing pages; and outputting, by an output control unit, in a manner that the second drawing page is added onto the first drawing page by not executing the command to end the first drawing page and the command to start the second drawing page.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an example of print data created by an application;

FIG. 2 is a diagram illustrating an example of drawing data of a stamp;

FIG. 3 is a diagram illustrating an example of the printed result expected when a stamp is placed on the front side of print data created by an application;

FIG. 4 is a diagram illustrating an example of the printed result occurring when a stamp is added to print data created by an application;

FIG. 5 is a general configuration diagram of a print system to which an information processing device according to a first embodiment of the present invention is connected;

FIG. 6 is a diagram illustrating an operation flow of a Windows (registered trademark) print architecture;

FIG. 7 is a sequence diagram illustrating a flow of a print operation by a print processor;

FIG. 8 is a sequence diagram illustrating a flow of a print operation by an application;

FIG. 9 is a sequence diagram illustrating a flow of a print command process by the print processor;

FIG. 10 is a sequence diagram illustrating a flow of a print command process by the print processor;

FIG. 11 is a sequence diagram illustrating a flow of a process of changing the order of sending a print command from the application to a printer driver;

FIG. 12 is a sequence diagram illustrating a timing of sending notices to the printer driver;

FIG. 13 is a sequence diagram illustrating a timing of sending notices to the printer driver;

FIG. 14 is a block diagram illustrating a configuration of a PC;

FIG. 15 is a diagram illustrating an example of print data created by the application;

FIG. 16 is a functional block diagram of the print processor;

FIG. 17 is a diagram illustrating an example of a first drawing page and a second drawing page generated by a generation unit;

FIG. 18 is a diagram illustrating a command sending order by a transceiver unit;

FIG. 19 is a diagram illustrating an order of sending a general command sent by a GDI;

FIG. 20 is a diagram illustrating a command sending order by a GDI according to the present embodiment;

FIG. 21 is a functional block diagram of the printer driver;

FIG. 22 is a diagram illustrating an example of an output page sent from the printer driver to a printer;

FIG. 23 is a sequence diagram illustrating a flow of a process in which a PC prints the print data which has the drawing data added thereto;

FIG. 24 is a block diagram illustrating the configuration of a PC according to the present embodiment;

FIG. 25 is a functional block diagram of the printer driver;

FIG. 26 is a sequence diagram illustrating a flow of a process in which a PC prints the print data which has the drawing data added thereto; and

FIG. 27 is a diagram illustrating a hardware configuration of the information processing device according to the first or the second embodiment.

### DETAILED DESCRIPTION OF THE PREFERRED EMBODIMENTS

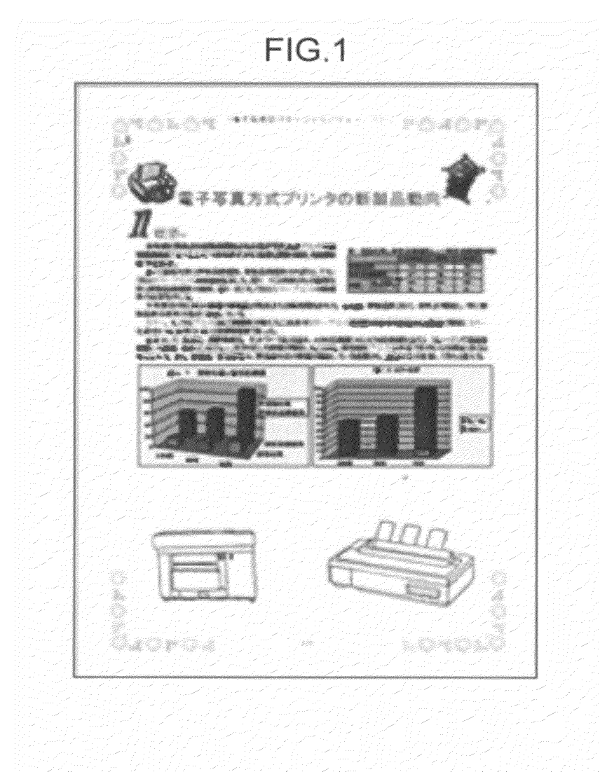

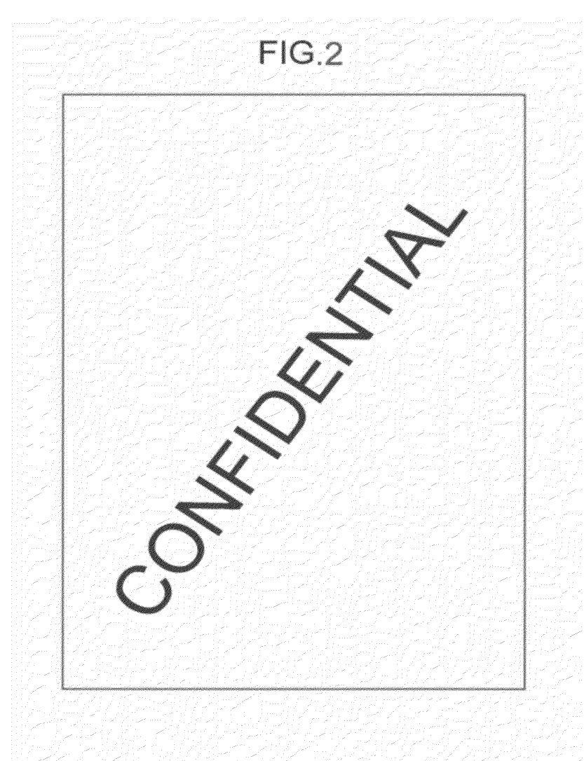

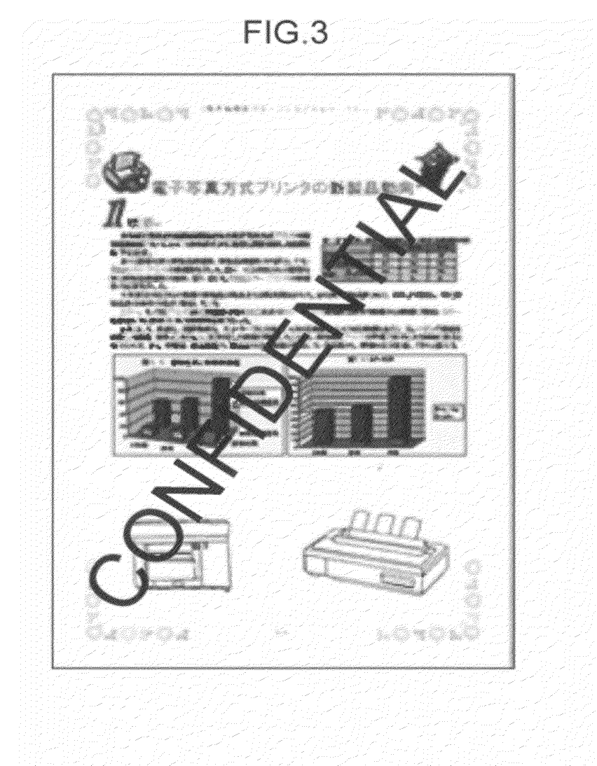

First, an example of print data to which drawing data is added by an information processing device of the related art will be described. FIG. 1 is a diagram illustrating an example of “print data created by an application” (hereinafter referred to as print data), and FIG. 2 is a diagram illustrating an example of drawing data of a stamp. FIG. 3 is a diagram illustrating an example of the printed result expected when a stamp is added to the front side of print data created by an application.

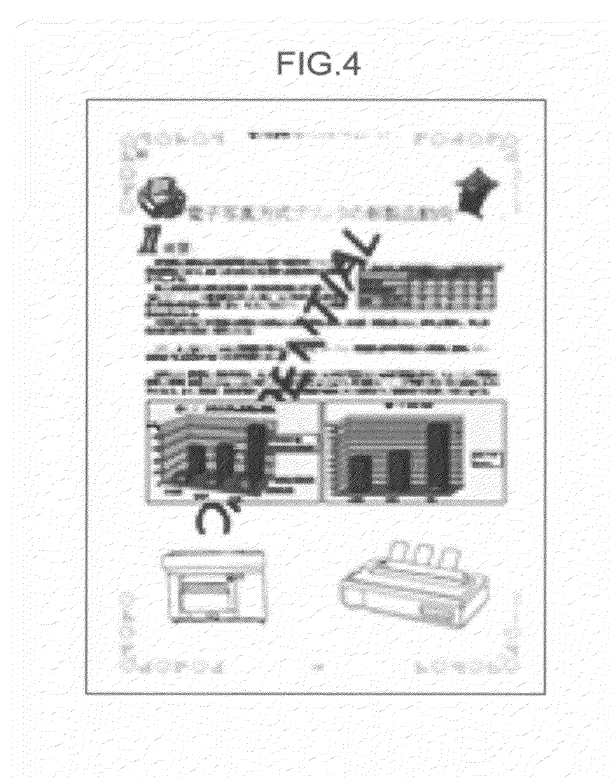

In the related art, when drawing data is added using an application program interface (API) that a print processor can use, “drawing data of a stamp to be added” (hereinafter referred to as a stamp) is printed on the back side of print data created by an application. As a result, a printed result as shown in FIG. 4 is obtained.

FIG. 4 is a diagram illustrating an example of the printed result occurring when a stamp is added to print data created by an application. In FIG. 4, focusing on the stamp in the graph figure at the center of print data created by an application, the graph figure appears on the front side of the stamp in the printed result. As above, in the related art, when drawing data is added to print data created by an application, the drawing data cannot be printed on the front side of the print data.

To solve this problem, preferred embodiments of a print program, an information processing device, and a recording medium according to the present invention will be described in detail with reference to the accompanying drawings.

### First Embodiment

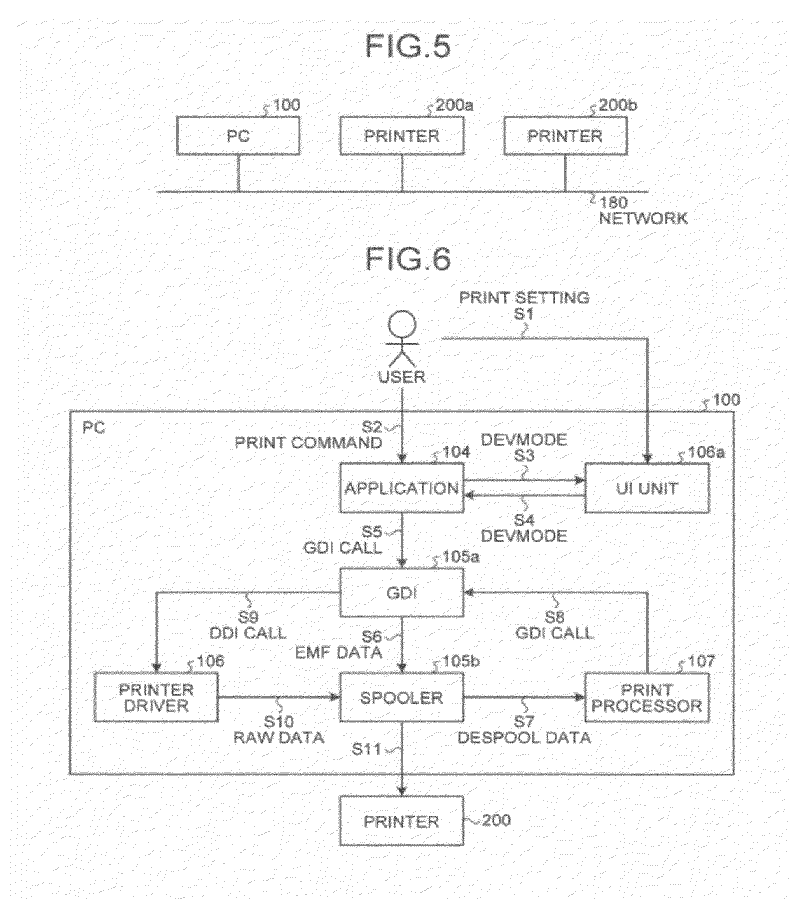

FIG. 5 is a general configuration diagram of a print system to which an information processing device according to a first embodiment of the present invention is connected. As shown in FIG. 5, the print system includes a personal computer (PC) 100 serving as the information processing device and printers 200a and 200b (hereinafter collectively referred to as a printer 200) which are connected by a network 180.

Upon receiving a command to add drawing data to print data from a user, the PC 100 generates drawing data in accordance with the command, sends a print command to the printer 200 with the print data and the generated drawing data together, and causes the printer 200 to perform printing.

Upon receiving the print command to add the drawing data to the print data from the PC 100, the printer 200 prints the print data and the drawing data in accordance with the print command from the PC 100.

First, the outline of a flow of a print operation by the PC 100 using Windows (registered trademark) print architecture will be described. FIG. 6 is a diagram illustrating an operation flow of Windows (registered trademark) print architecture. As illustrated in FIG. 6, the PC 100 includes a user interface unit (UI unit) 106a of a printer driver that receives a print setting from a user, an application 104 that receives a print command from the user, a Graphic Device Interface (GDI) 105a that sends a command from the print processor to a printer driver 106, and the printer driver 106 that converts the language format of data, a spooler 105b that stores print data, and a print processor 107 that edits the print data received from the spooler 105b. The PC 100 is connected to the printer 200. The details of the functions and configurations of the respective units will be described later.

First, the UI unit 106a receives a change in the print setting from the user (step S1). The application 104 receives a print command from the user (step S2). The application 104 receives the print setting of the user by exchanging data with the UI unit 106a and a structure (not illustrated) in which a print setting called DEVMODE is included (steps S3 and S4). In this case, the application 104 receives a designation of print data which is to be printed together with the print setting. The print data is a data created in the enhanced metafile format (EMF) in the course of processing by the application 104.

The application 104 delivers the print command of the print data to the GDI 105a through a GDI call (step S5). The GDI 105a delivers the print data in the EMF format to the spooler 105b as spool data (step S6). When the spooler 105b finishes spooling all print data created by the application 104, the spooler 105b sends a notice to the print processor 107 to despool the print data and then despools the print data to the print processor 107 (step S7).

The print processor 107 reads the print data received from the spooler 105b, edits the print data page by page, and delivers the edited content to the GDI 105a through a GDI call (step S8). In this case, the print processor 107 renders the print data to a device context in accordance with the print setting received by the UI unit 106a and edits the rendered device context. In this case, the print processor 107 edits the print data by each page of data rather than by each object on the page.

The GDI 105a delivers the GDI call received from the print processor 107 to the printer driver 106 as a device driver interface (DDI) call (step S9).

Upon receiving the DDI call received from the GDI 105a, the printer driver 106 converts the print data in the EMF format which is the subject of the print command into a RAW format and sends the RAW data obtained by converting to the spooler 105b (step S10).

The spooler 105b sends the RAW data received from the printer driver 106 to the printer 200 (step S11).

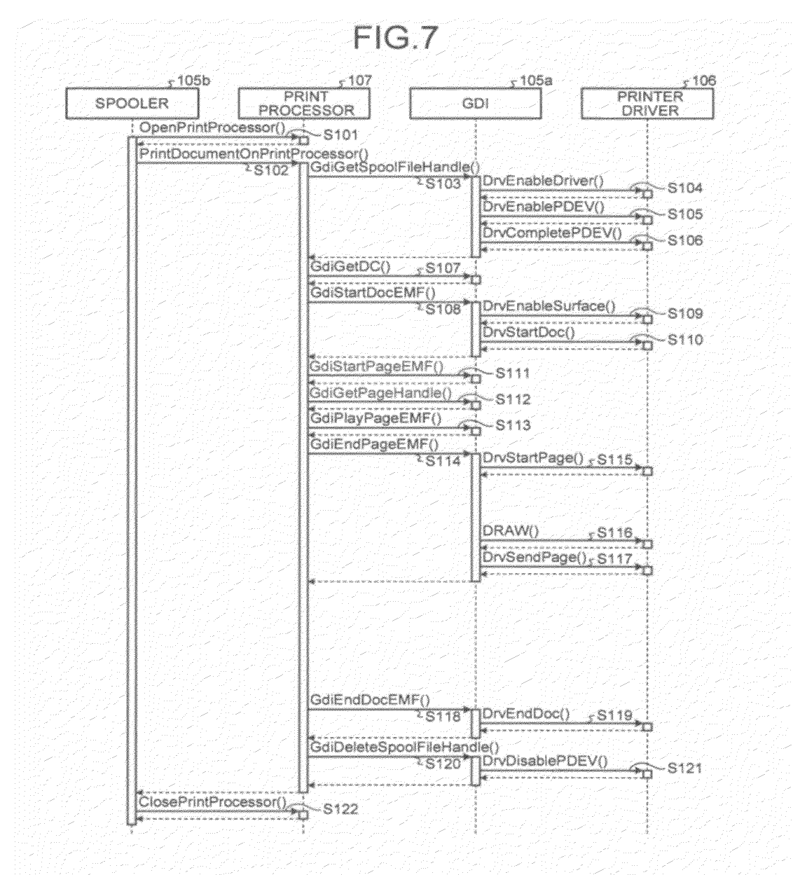

Next, the details of a print operation by a general print processor 107 based on the above outline will be described. FIG. 7 is a sequence diagram illustrating a flow of a print operation by the print processor 107.

The spooler 105b sends a print start request to the print processor 107 (step S101). In this case, the spooler 105b calls an OpenPrintProcesor( ) function with respect to the print processor 107, and the print processor 107 responds to this.

The spooler 105b sends the print processor 107 a notice of before print preparation (step S102). In this case, the spooler 105b calls a PrintDocumentOnPrintProcessor( ) function with respect to the print processor 107.

The print processor 107 sends the GDI 105a the notice of before print preparation (step S103). In this case, the print processor 107 calls a GdiGetSpoolFileHandle( ) function which is the Windows (registered trademark) GDI (hereinafter, referred to as a GDI) with respect to the GDI 105a. In this way, the GDI 105a acquires a handle to the print data which is spooled in the spooler 105b.

The GDI 105a sends the printer driver 106 a print preparation request (steps S104 to S106). In this case, the GDI 105a calls a DrvEnableDriver( ) function, a DrvEnablePDEV( ) function, and a DrvCompletePDEV( ) function which are the Windows (registered trademark) DDIs (hereafter referred to as DDIs) with respect to the printer driver 106.

The print processor 107 sends the GDI 105a a print start notice (steps S107 and S108). In this case, the print processor 107 calls a GdiGetDC( ) function which is a GDI with respect to the GDI 105a and acquires a device context which is an output destination of the print data. Moreover, the print processor 107 calls a GdiStartDocEMF( ) function which is a GDI and sends a print start notice to the GDI 105a.

The GDI 105a sends the printer driver 106 a print start notice (steps S109 and S110). In this case, the GDI 105a calls a DrvEnableSurface( ) function and a DrvStartDoc( ) function which are DDIs with respect to the printer driver 106.

The print processor 107 sends the GDI 105a the print data and sends a page start notice and a page end notice (steps S111 to S114). In this case, the print processor 107 calls various GDIs with respect to the GDI 105a.

For example, the print processor 107 calls a GdiStartPageEMF( ) function which is a GDI and sends a notice of the start of page of a print sheet. Moreover, the print processor 107 calls a GdiGetPageHandle( ) function which is a GDI and acquires one page of the print data. In this case, the print processor 107 can designate the page number of the print data. Furthermore, the print processor 107 calls a GdiPlayPageEMF( ) function which is a GDI and sends the print data to the GDI 105a. Furthermore, the print processor 107 calls a GdiEndPageEMF( ) function which is a GDI and sends a notice of ending of the allocation to print sheet (hereinafter referred to a notice of end of page).

The GDI 105a sends a page processing start request and the print data to the printer driver 106 (steps S115 to S117). In this case, the GDI 105a calls various DDIs with respect to the printer driver 106. For example, the GDI 105a calls a DrvStartPage( ) function, a Draw( ) function, and a DrvSendPage( ) function. Sending of the print data is generally called in the order of these functions.

The print processor 107 sends the GDI 105a a print end preparation request (step S118). In this case, the print processor 107 calls a GdiEndDocEMF( ) function which is a GDI with respect to the GDI 105a.

The GDI 105a sends the printer driver 106 the print end preparation request (step S119). In this case, the GDI 105a sends a DrvEndDoc( ) function which is a DDI to the printer driver 106.

The print processor 107 sends the GDI 105a a print end request (step S120). In this case, the print processor 107 calls a GdiDeleteSpoolFileHandle( ) function which is a GDI with respect to the GDI 105a and deletes the handle to print the data spooled in the spooler 105b.

The GDI 105a sends the printer driver 106 the print end request (step S121). In this case, the GDI 105a calls a DrvDisablePDEV( ) function which is a DDI with respect to the printer driver 106.

The spooler 105b sends the print processor 107 a notice of end of print (step S122). In this case, the spooler 105b calls a ClosePrintProcessor( ) function which is a GDI with respect to the print processor 107.

Since the exchange between the print processor 107 and the GDI 105a is carried out as above, the print processor 107 can allocate pages by using various GDIs including the GdiStartPageEMF( ) function, the GdiGetPageHandle( ) function, the GdiPlayPageEMF( ) function, and the GdiEndPageEMF( ) function.

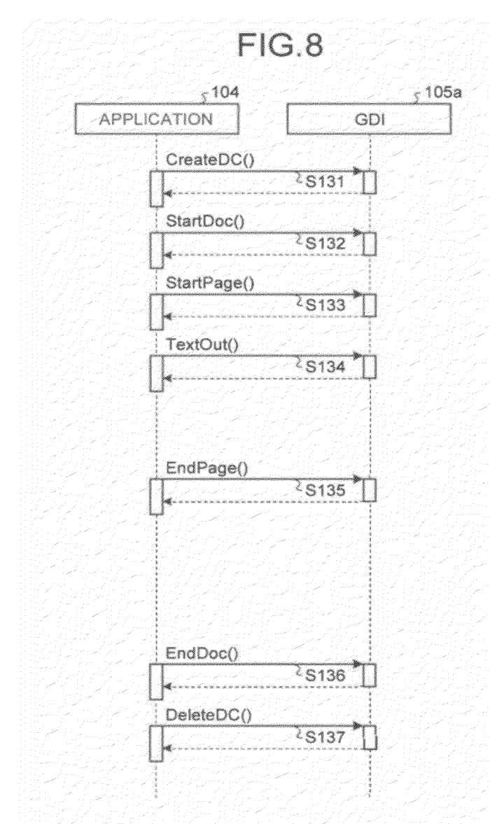

Next, the flow of a print operation by a general application 104 will be described. FIG. 8 is a sequence diagram illustrating a flow of a print operation by the application 104. In this example, although the application 104 calls the GDI 105a using an application program interface (API), the application 104 performs a drawing process on a device context as in the case of using GDIs.

First, an example of an API which is used when a general application performs a drawing process will be described. For example, a TextOut( ) function, a BitBlt( ) function, a StretchBlt( ) function, a LineTo( ) function, a Rectangle( ) function, and the like are used. These APIs are called between the StartPage( ) function and the EndPage( ) function, whereby characters, images, and graphics can be drawn in that page. Moreover, since the drawing destination is the device context, the print processor 107 can perform a drawing process using these APIs.

The application 104 sends a print start request and print data to the GDI 105a (steps S131 and S132). In this case, the application 104 calls a CreateDC( ) function and a StartDoc( ) function with respect to the GDI 105a.

Subsequently, the application 104 sends a page start request to the GDI 105a (step S133). The page start request is a request to prepare a page on which one page of print data will be drawn. The application 104 calls a StartPage( ) function with respect to the GDI 105a.

Subsequently, the application 104 sends the GDI 105a drawing data (step S134). In this case, the application 104 calls a TextOut( ) function with respect to the GDI 105a. When there is a plurality of drawing data, the application 104 may send the call a plurality of times.

After sending the drawing data, the application 104 sends the GDI 105a a page end request (step S135). The page end request is a request to end a page prepared by the page start request. The application 104 calls an EndPage( ) function with respect to the GDI 105a. When there is a plurality of pages of print data, the application 104 repeatedly performs the processes of steps S133 to S135, whereby the printer 200 can print a plurality of pages.

The application 104 sends the GDI 105a a print end request (steps S136 and S137). In this case, the application 104 calls an EndDoc( ) function and a DeleteDC( ) function with respect to the GDI 105a.

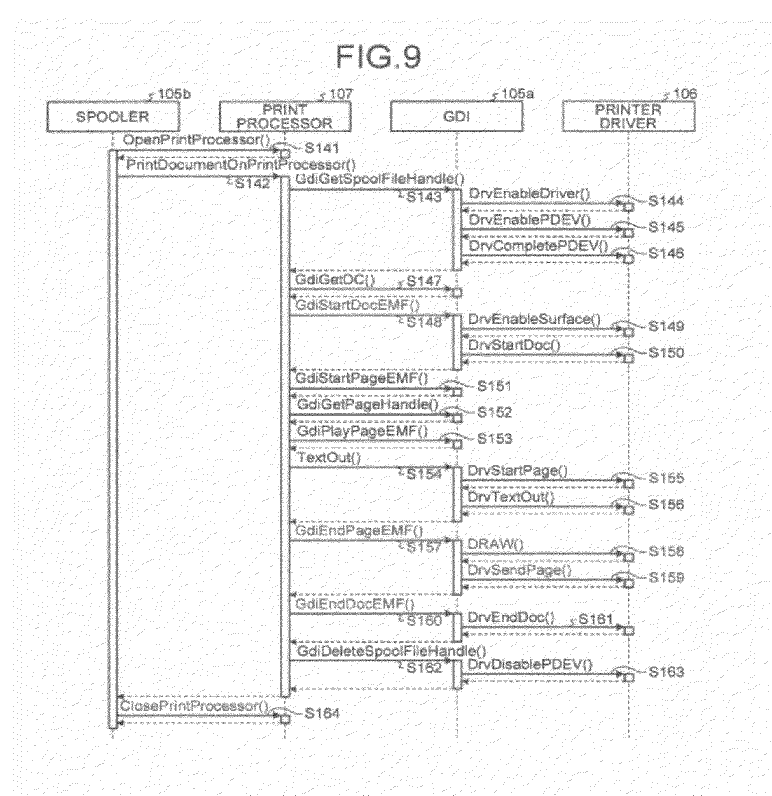

Next, the flow of a print command process by a general print processor 107 will be described. FIG. 9 is a sequence diagram illustrating a flow of a print command process by the print processor 107.

First, the outline of the processes by the GDI 105a and the print processor 107 will be described. First, immediately after the GDI 105a calls a page processing start command (DrvStartPage( ) which is a DDI of the printer driver 106, the GDI 105a calls a draw processing DDI on the printer driver 106 side, corresponding to a draw API called by the print processor 107.

When the print processor 107 does not call the draw API, no notice is sent to the printer driver 106 until the print processor 107 calls a GdiEndPageEMF( ) function. However, when the print processor 107 calls the draw API, the OS operates so that the command is directly sent to the printer driver 106.

The processes of steps S141 to S153 are the same as the processes of steps S101 to S113 described in the sequence diagram of FIG. 7.

The print processor 107 sends drawing data (step S154). In this case, the print processor 107 calls a TextOut( ) function with respect to the GDI 105a.

Focusing on the order of the called functions, the print processor 107 calls the TextOut( ) function following the GdiPlayPageEMF( ) function which is the GDI that was called in the previous processes (step S153).

The GDI 105a sends the printer driver 106 a page processing start request and the drawing data (steps S155 and S156). In this case, the GDI 105a calls a DrvStartPage( ) function and a DrvTextOut( ) function which are DDIs with respect to the printer driver 106.

The process of step S157 is the same as the process of step S114 described in the sequence diagram of FIG. 7.

The GDI 105a sends the printer driver 106 the print data (step S158). In this case, the GDI 105a calls a Draw( ) function which is a DDI with respect to the printer driver 106.

Focusing on the processes of steps S156 and S158, the GDI 105a first sends the drawing data in step S156 and then sends the print data in step S158. This is reverse to the order in steps S153 and S154 in which the print processor 107 sends the drawing data to the GDI 105a after the print data. That is, the printer driver 106 receives the print data and the drawing data in the reverse order to the order where they are sent from the print processor 107 to the GDI 105a. Thus, the drawing data is printed on the rear side of the print data.

The processes of steps S159 to S164 are the same as the processes of steps S117 to S122 described in the sequence diagram of FIG. 7.

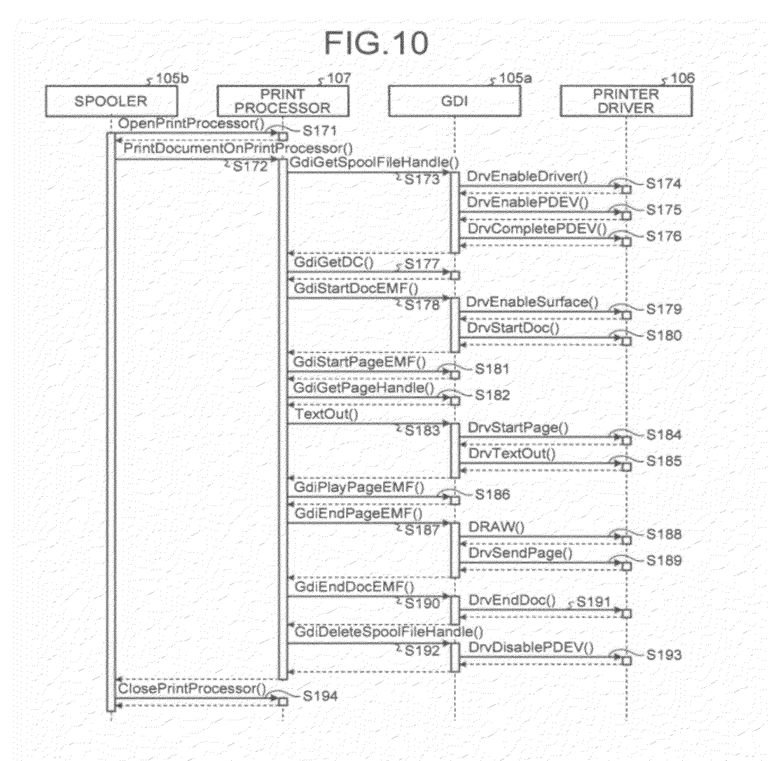

Next, another example of a print command process by a general print processor 107 using API calls will be described. FIG. 10 is a sequence diagram illustrating a flow of a print command process by the print processor 107.

The processes of steps S171 to S182 are the same as the processes of steps S141 to S152 described in the sequence diagram of FIG. 9.

The print processor 107 sends the drawing data to the GDI 105a (step S183). In this case, the print processor 107 calls a TextOut( ) function with respect to the GDI 105a.

The process of step S184 is the same as the process of step S115 described in the sequence diagram of FIG. 7. The GDI 105a sends the print data to the printer driver 106 (step S185). In this case, the GDI 105a calls a DrvTextOut( ) function with respect to the printer driver 106. Subsequently, the print processor 107 sends the print data to the GDI 105a (step S186). In this case, the print processor 107 calls a GdiPlayPageEMF( ) function which is a GDI with respect to the GDI 105a.

The print processor 107 sends the GDI 105a a page end request (step S187). In this case, the print processor 107 calls a GdiEndPageEMF( ) function which is a GDI with respect to the GDI 105a (step S187). The GDI 105a sends the printer driver 106 the print data (step S188). In this case, the GDI 105a calls a Draw( ) function to the printer driver 106.

Focusing on the processes of steps S183 and S186, the print processor 107 first sends the drawing data in step S183 and then sends the print data after the drawing data. This is different from the order in steps S153 and S154 in the sequence diagram of FIG. 9 in which the print processor 107 sends the drawing data after the print data.

However, the GDI 105a sends the printer driver 106 the drawing data in step S185 and then sends the print data in step S188 similarly to FIG. 9. That is, as shown in FIGS. 9 and 10, by changing the order of sending the print command from the print processor 107 to the GDI 105a, it is not possible to solve the problem in that the drawing data is still added to the back side of the print data.

The processes of steps S189 to S194 are the same as the processes of steps S159 to S164 described in the sequence diagram of FIG. 9.

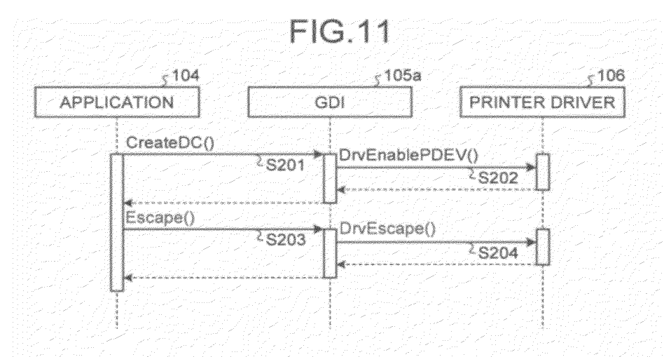

Next, a notice sending process in which the application 104 sends a notice (Escape) to the printer driver 106 will be described. Here, the Escape is a notice which is sent from the application 104 to the printer driver 106 through the GDI 105a. In this case, the application 104 sends a notice (hereinafter referred to a change notice) of change to a process of canceling a command using an Escape function to the printer driver 106. FIG. 11 is a sequence diagram illustrating a flow of a notice sending process from the application 104 to the printer driver 106.

The application 104 sends the printer driver 106 an Escape through the GDI 105a. Moreover, the GDI 105a calls a DrvEscape( ) function which is a DDI with respect to the printer driver 106. In this case, the Escape( ) function is also a process with respect to the device context, and the application 104 can exchange information with the printer driver 106 which performs printing. This exchange is carried out in accordance with the description of the Microsoft (registered trademark) msdn library.

The application 104 sends the GDI 105a a print data generation request (step S201). In this case, the application 104 calls a CreateDC( ) function with respect to the GDI 105a.

The GDI 105a sends the printer driver 106 a print start command (step S202). In this case, the GDI 105a calls a DrvEnablePDEV( ) function which is a DDI with respect to the printer driver 106.

Subsequently, the application 104 sends a notice (Escape) to the GDI 105a (step S203). In this case, the application 104 calls an Escape( ) function with respect to the GDI 105a. Then the GDI 105a sends the notice (Escape to the printer driver 106 (step S204). In this case, the GDI 105a calls a DrvEscape( ) function which is a DDI with respect to the printer driver 106

In this case, the function for sending the notice to the printer driver 106 is not limited to the Escape( ) function, and the application 104 may send the notice using an ExtEscape( ) function.

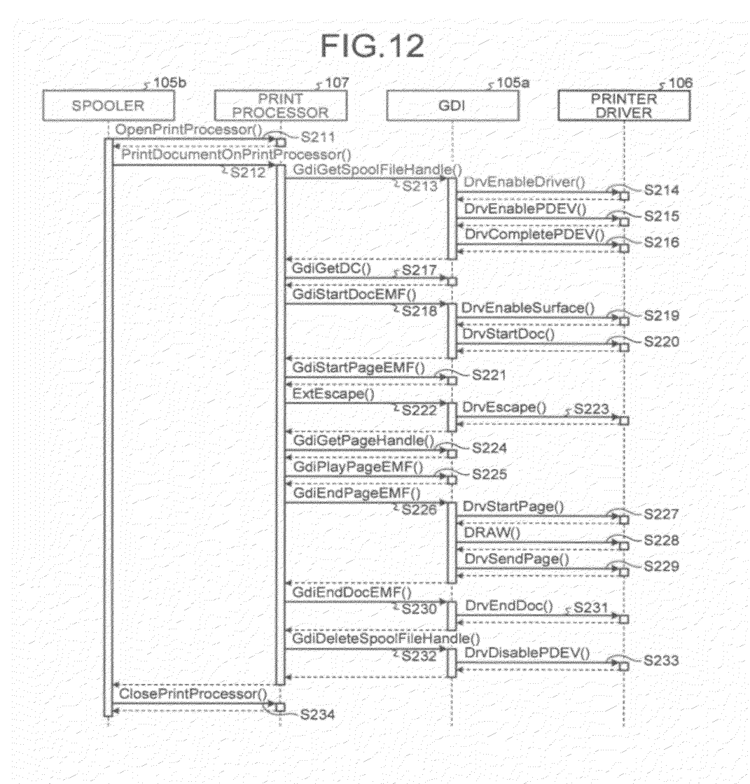

Next, the timing of sending a notice by the print processor 107 will be described. In this case, the printer driver 106 cancels a part of the command received from the GDI 105a when receiving a notice from the print processor 107. FIG. 12 is a sequence diagram illustrating a timing of sending a notice to the printer driver 106. In FIG. 12, the timing of sending a notice is added to the sequence diagram based on the sequence diagram of FIG. 7.

The processes of steps S211 to S221 are the same as the processes of steps S101 to S111 described in the sequence diagram of FIG. 7.

The print processor 107 sends a notice to the GDI 105a (step S222). In this case, the print processor 107 calls an ExtEscape( ) function with respect to the GDI 105a. In this case, although the print processor 107 sends the notice to the GDI 105a at the timing after sending a page start request in step S221, the sending timing is not limited to this.

The GDI 105a sends the notice to the printer driver 106 (step S223). In this case, the GDI 105a calls a DrvEscape( ) function which is a DDI with respect to the printer driver 106.

The processes of steps S224 to S234 are the same as the processes of steps S112 to S122 described in the sequence diagram of FIG. 7. In this case, similarly to the above, the print processor 107 can exchange information with the printer driver 106 through the GDI 105a by calling the Escape( ) function.

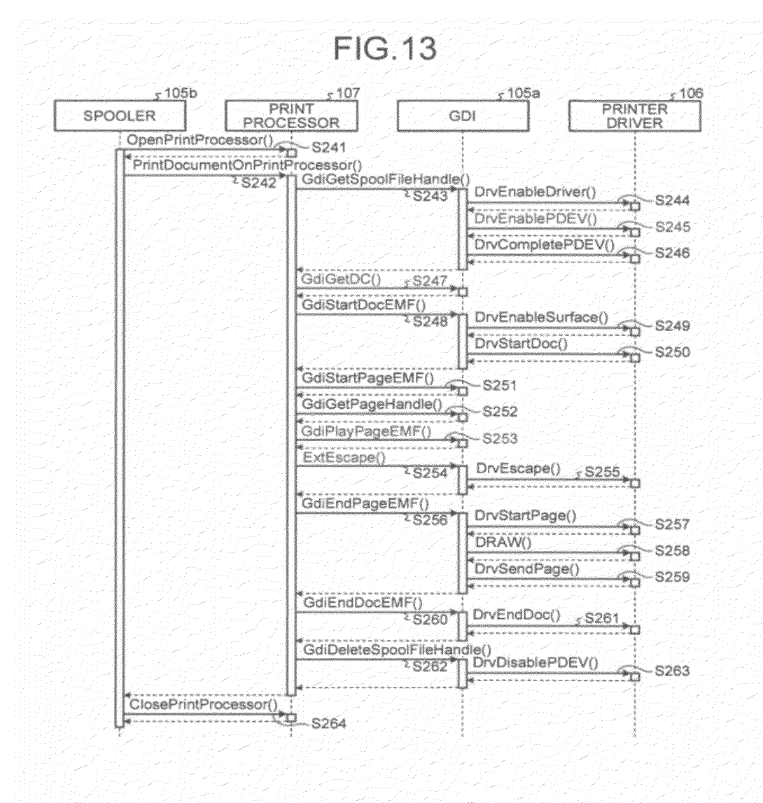

Next, another example of the timing of sending a notice by the print processor 107 will be described. FIG. 13 is a sequence diagram illustrating a timing of sending a notice to the printer driver 106. In FIG. 13, similarly to FIG. 12, the timing of sending a notice is added to the sequence diagram based on the sequence diagram of FIG. 7.

The processes of steps S241 to S253 are the same as the processes of steps S101 to S113 described in the sequence diagram of FIG. 7.

The print processor 107 sends a notice to the GDI 105a (step S254). In this case, the print processor 107 calls an ExtEscape( ) function with respect to the GDI 105a. In this case, although the print processor 107 sends the notice to the GDI 105a at the timing after sending print data in step S253, the sending timing is not limited to this similarly to FIG. 12 and may occur at an optional timing.

The GDI 105a sends the notice to the printer driver 106 (step S255). In this case, the GDI 105a calls a DrvEscape( ) function which is a DDI with respect to the printer driver 106.

The processes of steps S256 to S264 are the same as the processes of steps S114 to S122 described in the sequence diagram of FIG. 7.

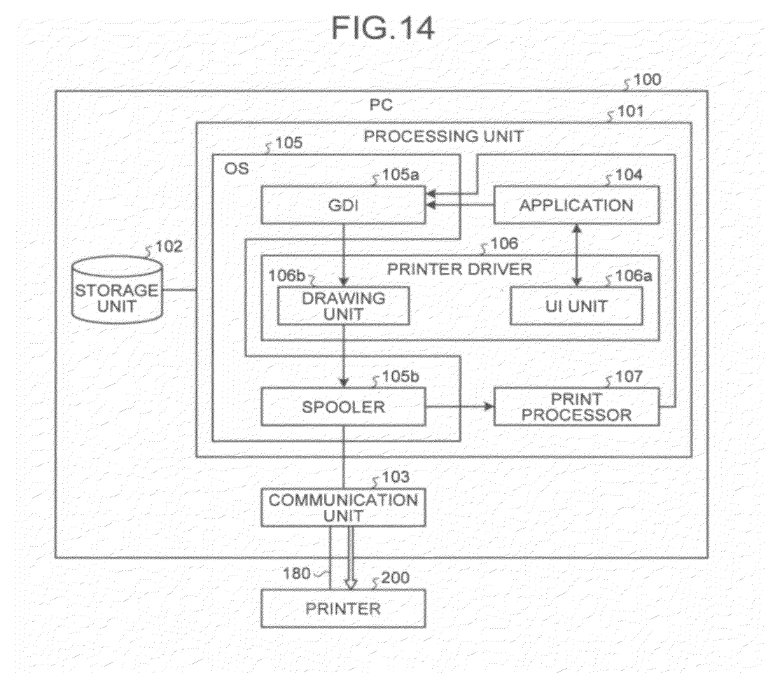

FIG. 14 is a block diagram illustrating a configuration of the PC 100. As shown in FIG. 14, the PC 100 includes a processing unit 101, a storage unit 102, and a communication unit 103. The processing unit 101 is configured to include a central processing unit (CPU) serving as a control means (not shown) and a group of memories including a read-only memory (ROM) and a random access memory (RAM) serving as a main memory. When the PC 100 is started and executed, the application 104, an operating system (OS) 105, various drivers (in FIG. 14, only the printer driver 106 is shown), and the print processor 107 are loaded and expanded onto a main memory from the ROM and the storage unit 102, and are executed by the CPU.

The PC 100 has a hardware configuration using a general computer which includes an input device such as a keyboard or a mouse and an output device such as a display, which however are not illustrated in FIG. 14 in order to simplify the description.

The functional blocks (described later) in the processing unit 101 shown in FIG. 14 are functions or means which serve as a main unit for realizing the print control of the printer 200.

The storage unit 102 is a storage means that stores various kinds of information. A hard disk drive (HDD) is a specific example thereof. The information stored in the storage unit 102 includes setting information which defines information (all kinds of information necessary for processing, such as setting values used for processing or display information for changing the setting values) regarding processing to realize the function of the printer driver 106.

The communication unit 103 is a network interface (network I/F) that transmits and receives information to and from the printer 200 connected through the network 180.

The application 104 is assumed to be software (for example, a word processor) that enables a user to instruct a print command. When the user wants to print data edited with the application 104, the application 104 receives a print command from the user. In this case, the application 104 does not generate print data with respect to the printer 200 by itself but rather delivers information on a print subject to the GDI 105a of the OS 105 through Graphics Device Interface (GDI) call, for example, together with a print request corresponding to the print command.

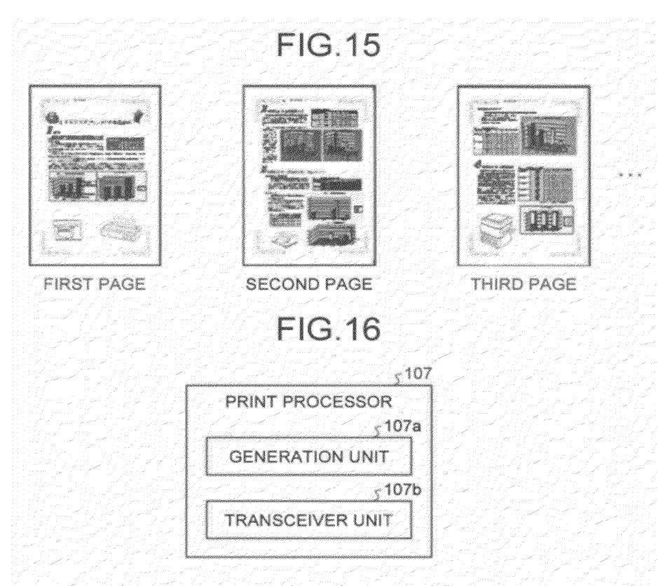

For example, the application 104 creates print data. FIG. 15 is a diagram illustrating an example of print data created by the application 104. As shown in FIG. 15, the application 104 generates page data sequentially from the first page.

The OS 105 is a program that controls the hardware and software of the PC 100. The OS 105 controls the start of programs, reading and storing of information, and the like. MS Windows (registered trademark) is a representative example of the OS. Moreover, the GDI 105a of the OS 105 delivers print subject information (text data, graphics data, image data, and the like) to the printer driver 106 through a device driver interface (DDI) call together with the print request including the setting information delivered from the application 104 through the GDI call. The print data generated by the printer driver 106 is stored sequentially in the spooler 105b and is delivered to the printer 200 through the communication unit 103.

The print processor 107 receives the spooled print data from the spooler 105b. Moreover, the print processor 107 generates drawing data to be added to the print data in accordance with the user instruction received by the application 104.

Next, the details of the print processor 107 will be described. FIG. 16 is a functional block diagram of the print processor 107. As shown in FIG. 16, the print processor 107 includes a generation unit 107a and a transceiver unit (transmitting and receiving unit) 107b.

The generation unit 107a generates a first drawing page and a second drawing page. The first drawing page is a page on which print data is drawn, and the second drawing page is a page on which drawing data to be drawn onto the print data is drawn. As for the first drawing page, the generation unit 107a may use page data despooled from the spooler 105b as the drawing data. When the UI unit 106a designates a plurality of drawing data to be added to the print data, the generation unit 107a may draw the designated plurality of drawing data on different pages to generate a plurality of second drawing pages. In this case, the generation unit 107a may draw the designated plurality of drawing data on one page to generate one second drawing page.

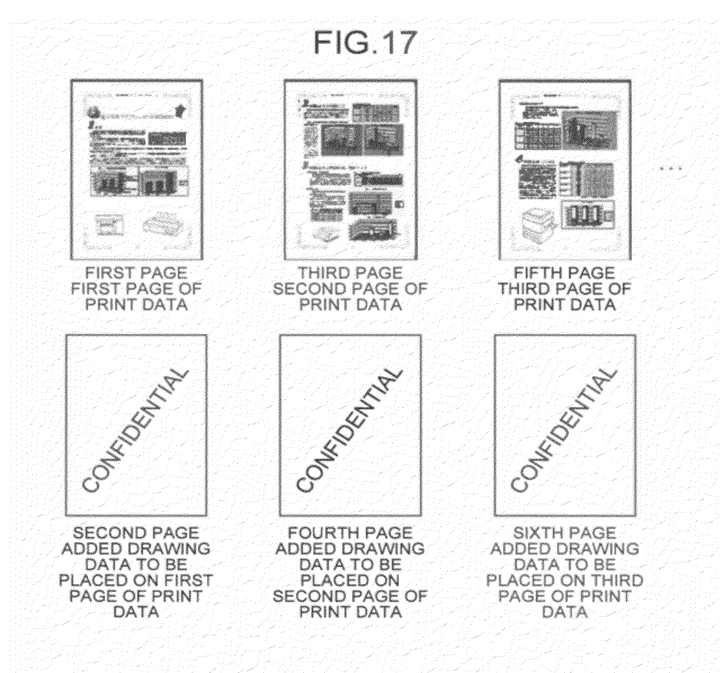

Next, an example of generating the second drawing page by the generation unit 107a will be described. FIG. 17 is a diagram illustrating an example of the first and second drawing pages generated by the generation unit 107a.

In FIG. 17, the generation unit 107a replays the first page of print data despooled from the spooler 105b to the first page to generate the first drawing page. Then, the generation unit 107a prepares an imaginary page as a page for printing a second drawing page to be added to the first page of the print data on the second page and places the drawing data on the prepared imaginary page to generate the second drawing page.

Similarly, the generation unit 107a replays the second page of print data despooled from the spooler 105b to the third page to generate the first drawing page. Then, the generation unit 107a prepares an imaginary page as a page for printing a second drawing page to be added to the second page of the print data on the fourth page and places the drawing data on the prepared imaginary page to generate the second drawing page. Furthermore, similarly, with respect to the fifth and sixth pages, the generation unit 107a arranges the drawing data of the third page of the print data onto the fifth page, arranges the drawing data to be added onto the third page of the print data onto the sixth page. The generation unit 107a repeatedly performs this process up to the page of the drawing data to be added to the last page of the print data.

When a plurality of second drawing pages are generated, the generation unit 107a arranges the drawing data to be added to the first drawing page on pages subsequent to the first drawing page. For example, when two pages of the second drawing page are generated, the generation unit 107a generates the first drawing page on the first page and generates the drawing data of the second drawing page on the second and third pages.

The transceiver unit 107b has a function of a transmitting unit that sends the second drawing page subsequent to the first drawing page. The transceiver unit 107b sends the printer driver 106 the first and second drawing pages generated by the generation unit 107a through the GDI 105a in accordance with a predetermined command.

Moreover, the transceiver unit 107b sends a command to start each of the first and second drawing pages and a command to end each of the first and second drawing pages to the printer driver 106 through the GDI 105a.

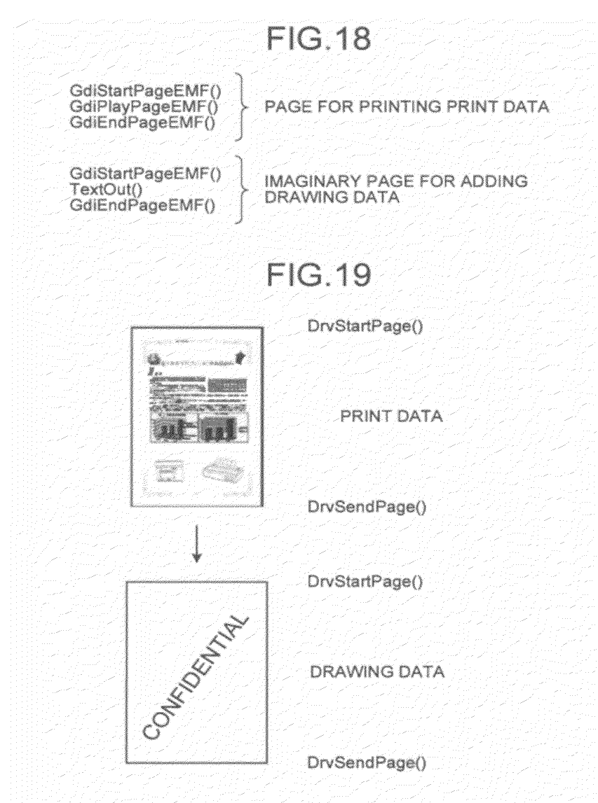

Next, an example of a command used when the transceiver unit 107b sends the drawing page will be described. FIG. 18 is a diagram illustrating a command sending order by the transceiver unit 107b. As shown in FIG. 18, the transceiver unit 107b calls a GdiStartPageEMF( ) function, a GdiPlayPageEMF( ) function, and a GdiEndPageEMF( ) function which are GDIs sequentially with respect to the GDI 105a as commands for sending the first drawing page to the printer driver 106. Moreover, the transceiver unit 107b calls a GdiStartPageEMF( ) function, a TextOut( ) function, and a GdiEndPageEMF( ) function which are GDIs sequentially with respect to the GDI 105a as command for sending the second drawing page.

Next, a command sending order in which the GDI 105a having received commands from the transceiver unit 107b sends commands to the printer driver 106 will be described. FIG. 19 is a diagram illustrating an order of sending a general command by the GDI 105a. In general, the GDI 105a sends commands received from the print processor 107 to the printer driver 106. For example, as shown in FIG. 19, as for the first page, the GDI 105a calls a DrvStartPage( ) function which is a DDI, sends print data, and calls a DrvSendPage( ) function. Subsequently, as for the second page, the GDI 105a calls a DrvStartPage( ) function, sends drawing data, and calls a DrvSendPage( ) function.

However, when the GDI 105a sends command to the printer driver 106 in general command sending order as above, the second page of drawing data (imaginary page) to be added to the first page of print data is output as a different page from the first page of print data.

Thus, in the present embodiment, the GDI 105a cancels a part of the command by executing a part of the command so that the second page of drawing data is output to be added on the first page of print data.

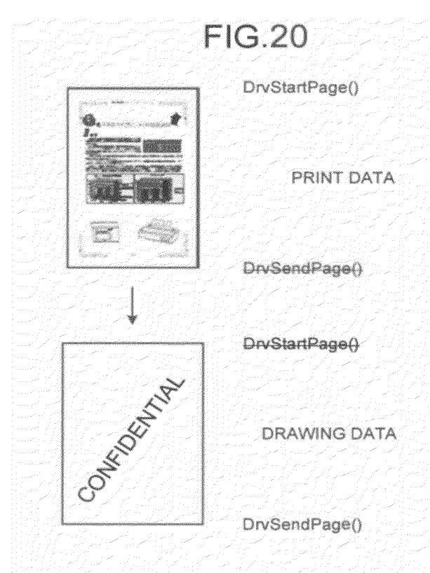

FIG. 20 is a diagram illustrating a command sending order by the GDI 105a according to the present embodiment. As shown in FIG. 20, as for the first page, the GDI 105a starts a page by calling a DrvStartPage( ) function which is a DDI and then sends print data. In this case, the GDI 105a calls a DrvSendPage( ) function and a DrvStartPage( ) function. After sending the print data, the GDI 105a sends the drawing data and calls a DrvSendPage( ) function to end the page.

In this way, the imaginary page on which the second drawing page is drawn will not be sent as a new page. Thus, the imaginary page on which the second drawing page is drawn will be added onto the same page of print data as the print data that is drawn to the first drawing page.

The printer driver 106 sends the print data and the drawing data to the printer 200 in accordance with a command from the print processor 107.

As above, the print processor 107 sends the printer driver 106 a notice of change to a process of canceling a command using the Escape function. In response to this notice, the printer driver 106 cancels the page end notice of the print data sent from the GDI 105a and the page start notice of the imaginary page added by the print processor 107. In this way, the imaginary page will not be output by the printer 200. When a plurality of second drawing pages are generated by the generation unit 107a, the printer driver 106 cancels the page start notice of the imaginary pages corresponding to the generated second drawing pages.

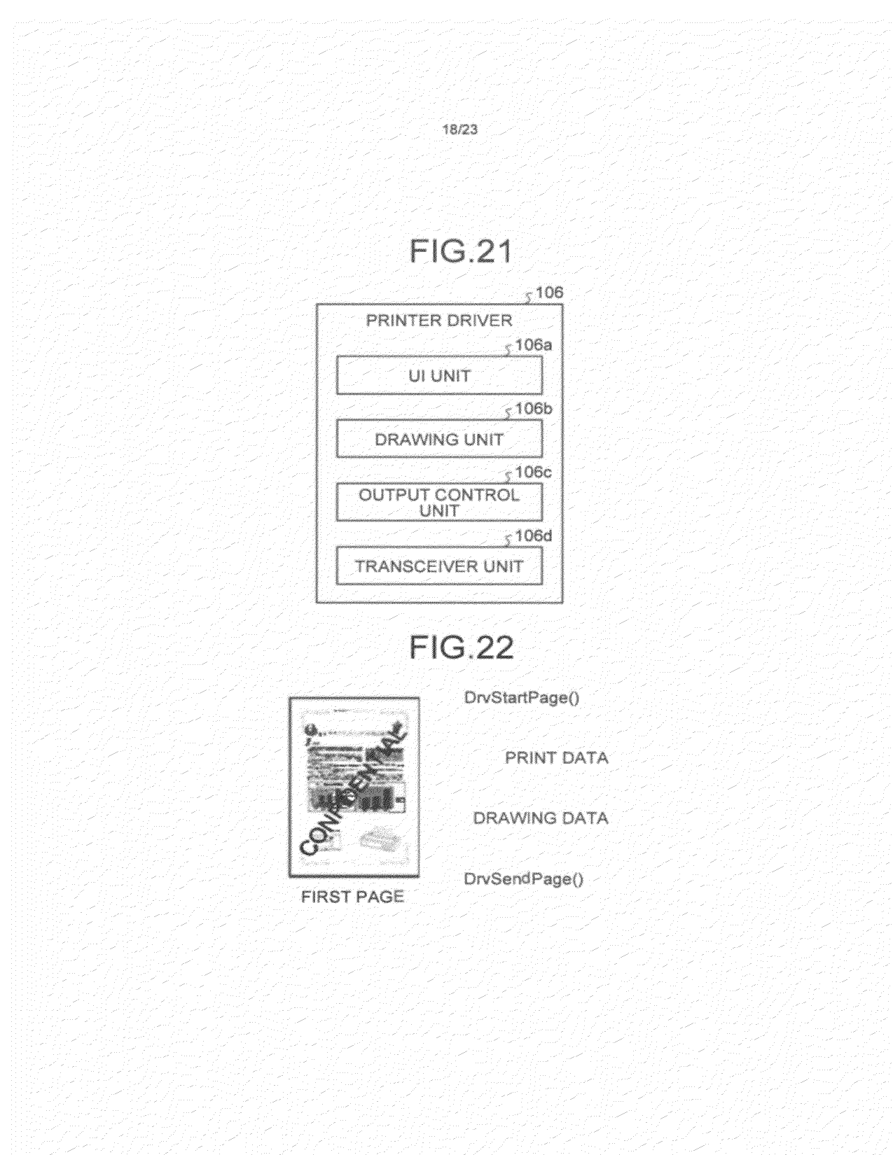

Next, the details of the printer driver 106 will be described with reference to FIG. 21. FIG. 21 is a functional block diagram of the printer driver 106. As shown in FIG. 21, the printer driver 106 includes the UI unit 106a, a drawing unit 106b, an output control unit 106c, and a transceiver unit (transmitting and receiving unit) 106d. In the present embodiment, a monolithic driver for vendor's development is used as the printer driver 106.

The UI unit 106a controls a user interface (UI) that receives the print settings input by the user.

The drawing unit 106b converts the print data created by the application 104 into a format that can be understood by the printer. For example, the drawing unit 106b converts the print data created in the Enhanced Metafile Format (EMF) format by the application 104 into a RAW format.

The transceiver unit 106d receives the first drawing page and the second drawing page from the print processor 107 through the GDI 105a. Moreover, the transceiver unit 106d receives commands from the GDI 105a.

Moreover, the transceiver unit 106d has a function of a receiving unit that receives a command to start each of the first and second drawing pages and a command to end each of the first and second drawing pages from the print processor 107 through the GDI 105a.

The output control unit 106c receives the first and second drawing pages from the print processor 107 and outputs the first drawing page to which the second drawing page is added to the printer 200 in accordance with the command received from the GDI 105a. For example, the output control unit 106c outputs the first drawing page onto which the second drawing page is added, to the printer 200 by executing the command to start the first drawing page and the command to end the second drawing page received by the transceiver unit 106d and does not execute the command to end the first drawing page and the command to start the second drawing page.

FIG. 22 is a diagram illustrating an example of an output page send from the printer driver 106 to the printer 200. The output page means a page in which the print data (including the drawing data) to be printed on one page of a print sheet by the printer 200 is drawn. As shown in FIG. 22, the printer driver 106 sends an output page in which the drawing data drawn to the second drawing page is added onto the print data drawn to the first drawing page to the printer 200 in accordance with the command sent from the GDI 105a.

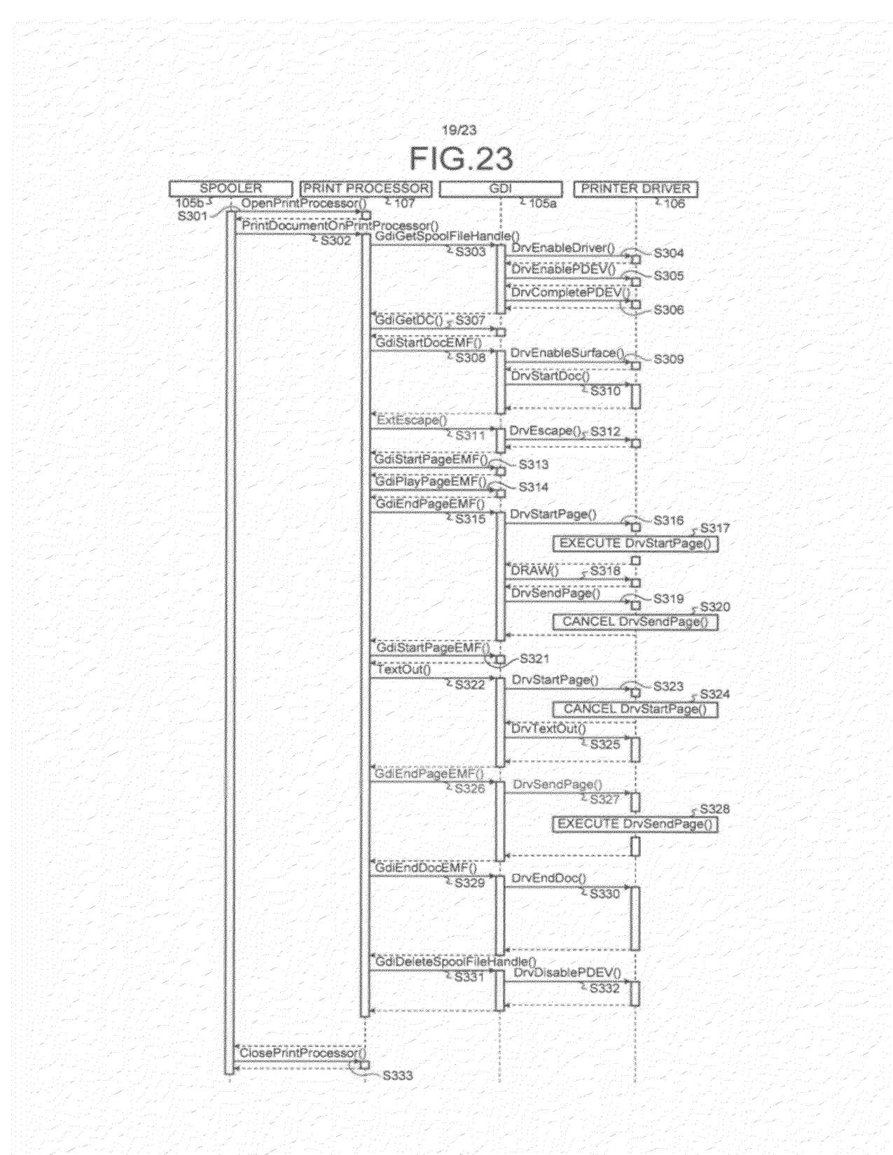

Next, a flow of a process in which the PC 100 having the above configuration prints the print data to which the drawing data is added will be described. FIG. 23 is a sequence diagram illustrating a flow of a process in which the PC 100 prints the print data which has the drawing data added thereto.

The processes of steps S301 to S310 are the same as the processes of steps S101 to S110 described in the sequence diagram of FIG. 7.

The print processor 107 sends a print start command to the GDI 105a (step S311). In this case, the print processor 107 calls an ExtEscape( ) function with respect to the GDI 105a. In this way, the print processor 107 sends print information including the drawing data to the GDI 105a.

The GDI 105a sends a notice to the printer driver 106 (step S312). In this case, the GDI 105a calls a DrvEscape( ) function which is a DDI with respect to the printer driver 106. In this way, the subsequent operations are changed to a print process of adding the drawing data onto the print data.

The processes of steps S313 to S316 are the same as the processes of steps S111 and S113 to S115 described in the sequence diagram of FIG. 7.

The printer driver 106 executes a page start command in response to the page start request from the GDI 105a (step S317). In this case, the printer driver 106 executes a DrvStartPage( ) function which is a DDI from the GDI 105a. In this way, the page start request is executed with respect to the print pages (odd pages) sent from the print processor 107.

The processes of steps S318 and S319 are the same as the processes of steps S116 and S117 described in the sequence diagram of FIG. 7. In step S318, the GDI 105a sends the print data to the printer driver 106.

In response to the change notice using the Escape function, the printer driver 106 cancels the page end request from the GDI 105a and does not execute the page end command (step S320). In this case, the printer driver 106 performs canceling or the like of commands depending on whether or not a change notice is received from the print processor 107. After receiving the change notice, the printer driver 106 cancels the call of the DrvSendPage( ) function which is a DDI from the GDI 105a.

In this way, the printer driver 106 does not end the output page in which the print data sent in step S318 is drawn and stands by for reception of the drawing data which is continuously sent. Other methods and functions may be used as long as it can send a notice from the print processor 107 to the printer driver 106.

The processes of steps S321 to S323 are the same as the processes of steps S181 to S185 (steps S181, S183 and S184) described in the sequence diagram of FIG. 10. In step S321, the print processor 107 sends the imaginary page, on which the drawing page is drawn, to the printer driver 106.

The printer driver 106 cancels the page start request from the GDI 105a and does not execute the page start command (step S324). In this case, the printer driver 106 cancels the call of a DrvStartPage( ) function which is a DDI from the GDI 105a. In this way, the printer driver 106 does not start a new page.

The processes of steps S325 to S327 (S326) are the same as the processes of steps S156 and S157 described in the sequence diagram of FIG. 9. The GDI 105a sends the drawing data to the printer driver 106 in step S325. The printer driver 106 adds the received drawing data onto the output page on which the print data, which has been received in step S318, is drawn.

The GDI 105a sends a page end request to the printer driver 106 (step S327). In this case, the GDI 105a calls a DrvSendPage( ) function which is a DDI with respect to the printer driver 106.

In response to the page end request from the GDI 105a, the printer driver 106 executes a page end command (step S328). In this case, the printer driver 106 executes a DrvSendPage( ) function which is a DDI from the GDI 105a. The printer driver 106 outputs an output page in which the drawing data is added onto the print data to the printer 200.

The processes of steps S329 to S333 are the same as the processes of steps S118 to S122 described in the sequence diagram of FIG. 7.

As above, according to the present embodiment, when the PC receives a setting to add drawing data onto print data, the print processor generates a first drawing page on which the print data is drawn and a second drawing page on which drawing data is drawn, and the printer driver outputs the generated two pages to one page by adding the two pages on one page in the reception order. In this way, it is possible to print the drawing data to be added on the front side of the print data.

### Second Embodiment

In the first embodiment, a monolithic driver is used as the printer driver of the PC 100. In contrast, in the present embodiment, a mini-driver for development using the Microsoft (registered trademark) system is used as the printer driver.

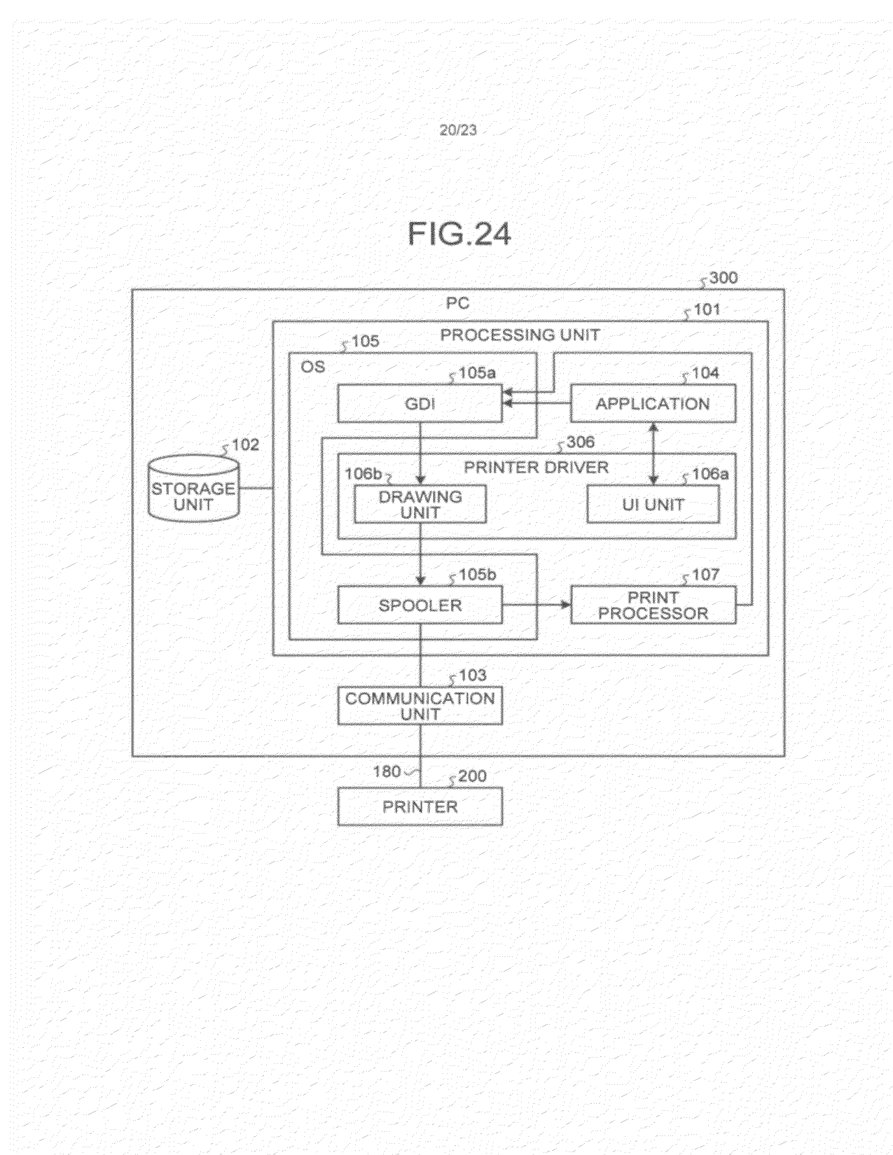

First, the configuration of a PC 300 according to the present embodiment will be described. The general configuration of a print system to which an information processing device according to the second embodiment is connected is the same as that of the first embodiment. FIG. 24 is a block diagram illustrating a configuration of the PC 300 according to the present embodiment. As shown in FIG. 24, the PC 300 includes the processing unit 101, the storage unit 102, and the communication unit 103. The processing unit 101 is configured to include a CPU serving as a control means (not shown) and a group of memories including a ROM and a RAM serving as a main memory. When the PC 300 is started and executed, the application 104, the OS 105, a printer driver 306, and the print processor 107 are loaded and expanded onto a main memory from the ROM and the storage unit 102, and are executed by the CPU. The functions and configurations of the respective units other than the printer driver 306 are the same as those of the first embodiment, and a redundant description thereof will not be provided.

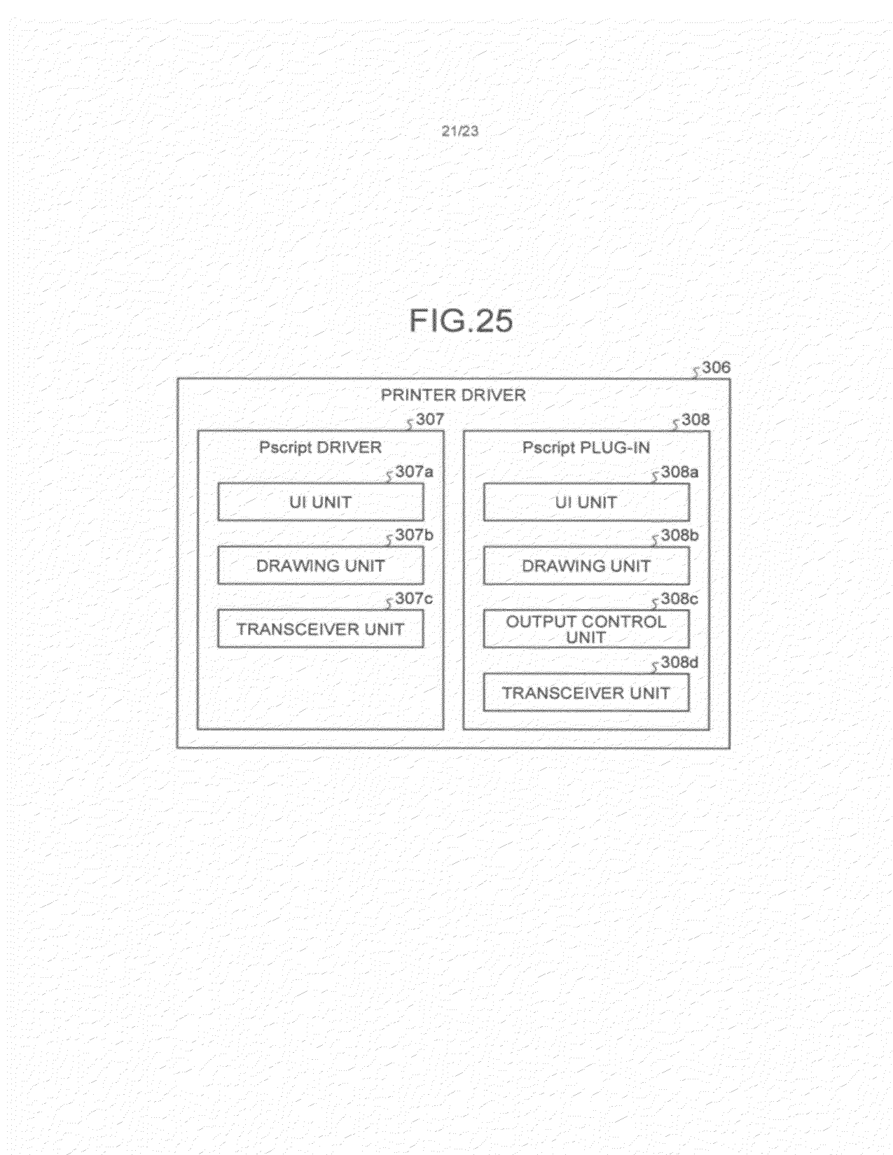

FIG. 25 is a functional block diagram of the printer driver 306. In the present embodiment, a mini-driver using the Microsoft (registered trademark) system is used as the printer driver 306.

As shown in FIG. 25, the printer driver 306 includes a Pscript driver 307 which is a mini-driver and a Pscript plug-in 308 for adding functions to the Pscript driver 307. Although an example of using a Pscript driver as the mini-driver is described, the mini-driver is not limited to this, and may be a Universal printer driver library (Unidrv) or the like, for example.

First, the Pscript driver 307 includes an UI unit 307a, a drawing unit 307b, and a transceiver unit (transmitting and receiving unit) 307c.

The UI unit 307a controls a user interface (UI) that receives the print setting input by the user.

The drawing unit 307b converts the print data created by the application 104 into a format that can be understood by the printer. For example, the drawing unit 307b converts the print data created in the EMF format by the application 104 into a RAW format.

The transceiver unit 307c receives the first drawing page and the second drawing page from the print processor 107 through the GDI 105a. Moreover, the transceiver unit 307c receives commands from the GDI 105a.

Moreover, the Pscript plug-in 308 includes a UI unit 308a, a drawing unit 308b, an output control unit 308c, and a transceiver unit (transmitting and receiving unit) 308d.

The UI unit 308a controls the user interface (UI) that receives the print settings input by the user.

The drawing unit 308b converts the print data created by an application into a format that can be understood by the printer. For example, the drawing unit 308b converts the print data created in the EMF format by the application into a RAW format.

The transceiver unit 308d receives the first drawing page and the second drawing page from the print processor 107 through the Pscript driver 307. Moreover, the transceiver unit 308d receives commands from the GDI 105a.

The output control unit 308c receives the first and second drawing pages from the Pscript driver 307 and outputs the first drawing page to which the second drawing page is added to the printer 200 in accordance with the command received from the Pscript driver 307. For example, the output control unit 308c outputs an output page in which the first drawing page having the second drawing page added to the printer 200 is drawn to the printer 200 by executing a page start command, calling the first drawing page (print data) and the second drawing page (drawing data), and executing a page end command.

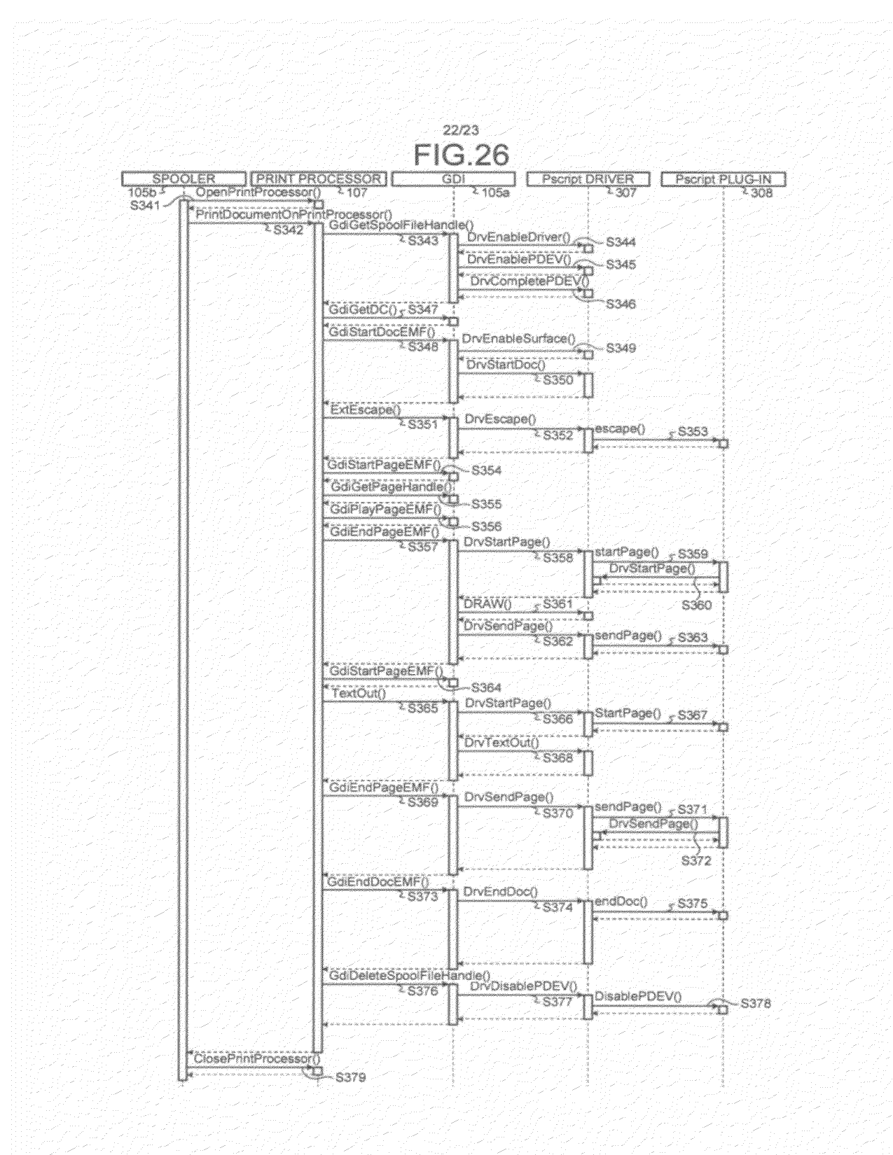

Next, a flow of a process in which the PC 300 having the above configuration prints the print data to which the drawing data is added will be described. FIG. 26 is a sequence diagram illustrating a flow of a process in which the PC 300 prints the print data which has the drawing data added thereto.

The processes of steps S341 to S352 are the same as the processes of steps S301 to S312 described in the sequence diagram of FIG. 23. The processes of the Pscript driver 307 among the processes of steps S341 to S352 corresponds to the processes of the printer driver 106 in FIG. 23.

The Pscript driver 307 sends a notice to the Pscript plug-in 308 (step S353). The Pscript driver 307 calls an escape( ) function which is a DDI with respect to the Pscript plug-in 308. In this way, the Pscript plug-in 308 changes the subsequent operations to a print process of adding the drawing data onto the print data.

The processes of steps S354 to S355 (S358) are the same as the processes of steps S111 to S115 described in the sequence diagram of FIG. 7.

The Pscript driver 307 sends a page start request to the Pscript plug-in 308 (step S359). In this case, the Pscript driver 307 calls a startPage( ) function which is a DDI with respect to the Pscript plug-in 308. In response to the Pscript driver 307, the Pscript plug-in 308 executes a page start command (step S360). In this case, the Pscript driver 307 calls a DrvStartPage( ) function which is a DDI with respect to the Pscript plug-in 308.

The processes of steps S361 and S362 are the same as the processes of steps S318 and S319 described in the sequence diagram of FIG. 23.

The Pscript driver 307 sends a page end request to the Pscript plug-in 308 (step S363). In this case, the Pscript driver 307 sends a sendPage( ) function which is a DDI with respect to the Pscript plug-in 308.

In this case, the Pscript plug-in 308 does not respond the page end request from the Pscript driver 307 and does not execute the page end command.

The processes of steps S364 to S366 are the same as the processes of steps S321 to S323 described in the sequence diagram of FIG. 23.

The Pscript driver 307 sends a page start request to the Pscript plug-in 308 (step S367). In this case, the Pscript driver 307 calls a StartPage( ) function which is a DDI with respect to the Pscript plug-in 308.

In this case, the Pscript plug-in 308 does not respond the page start request from the Pscript driver 307 and does not execute the page start command.

The processes of steps S368 to S370 are the same as the processes of steps S325 to S327 described in the sequence diagram of FIG. 23.

In step S371, the Pscript driver 307 sends a page end request to the Pscript plug-in 308. In this case, the Pscript driver 307 sends a sendPage( ) function which is a DDI with respect to the Pscript plug-in 308 (step S371).

In response to this, the Pscript plug-in 308 executes the page end command (step S372). In this case, the Pscript plug-in 308 calls a DrvSendPage( ) function which is a DDI with respect to the Pscript driver 307 (step S372).

The processes of steps S373 and S374 are the same as the processes of steps S329 and S330 described in the sequence diagram of FIG. 23.

The Pscript driver 307 sends a print end preparation request to the Pscript plug-in 308 (step S375). In this case, the Pscript driver 307 calls an endDoc( ) function which is a DDI with respect to the Pscript plug-in 308.

The processes of steps S376, S377, and S379 are the same as the processes of steps S331 to S333 described in the sequence diagram of FIG. 23.

The Pscript driver 307 sends a print end request to the Pscript plug-in 308 (step S378). In this case, the Pscript driver 307 calls a DisablePDEV( ) function which is a DDI with respect to the Pscript plug-in 308.

The print processor 107 sends a print start command to the GDI 105a (step S311). In this case, the print processor 107 calls an ExtEscape( ) function with respect to the GDI 105a. In this way, the print processor 107 sends print information including the drawing data to the printer driver 106.

The GDI 105a sends a notice to the printer driver 106 (step S312). In this case, the GDI 105a calls a DrvEscape( ) function which is a DDI with respect to the printer driver 106. In this way, the subsequent operations are changed.

As above, according to the present embodiment, when the PC receives a setting to add drawing data onto print data, the print processor generates a first drawing page on which the print data is drawn and a second drawing page on which drawing data is drawn, and the Pscript plug-in outputs the generated two pages to one page by adding the two pages on one page in the reception order. In this way, it is possible to print in a manner that the drawing data is added onto the front side of the print data.

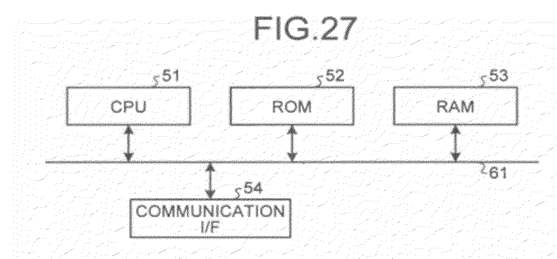

Next, a hardware configuration of the information processing device according to the first and second embodiments will be described with reference to FIG. 27. FIG. 27 is a diagram illustrating a hardware configuration of the information processing device according to the first or the second embodiment.

The information processing device according to the first or the second embodiment has a hardware configuration using a general computer which includes a control device such as a central processing unit (CPU) 51, a storage device such as a read only memory (ROM) 52 and a random access memory (RAM) 53, a communication I/F 54 that performs communication by being connected to a network, an external storage device such as a hard disk drive (HDD), a compact disc (CD) drive device, a display device such as a display, an input device such as a keyboard or a mouse, and a bus 61 that connects the respective units to each other.

A print program executed by the information processing device according to the first or second embodiment is recorded in a computer-readable recording medium, such as a Compact Disk Read Only Memory (CD-ROM), a flexible disk (FD), a Compact Disk Recordable (CD-R), or a Digital Versatile Disk (DVD), as files in an installable format or an executable format and provided as a computer program product.

Furthermore, the print program executed by the information processing device according to the first or the second embodiment may be stored on a computer connected to a network such as the Internet and provided by being downloaded through the network. In addition, the print program executed by the information processing device according to the first or the second embodiment may be provided or distributed through a network such as the Internet.

Furthermore, the print program according to the first and the second embodiments may be provided in a state of being stored in advance in a ROM or the like.

The print program executed by the information processing device according to the first or the second embodiment has a modular configuration which includes the above-described respective units (the generation unit, the drawing unit, the output control unit, and the transceiver unit (transmitting and receiving unit)), and the CPU 51 (processor) which is an actual hardware configuration reads the print program from the recording medium and executes the print program, whereby the respective units are loaded onto the main storage device, and the respective units are generated on the main storage device.

According to the present embodiments, drawing data can be printed on print data created by an application.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing device comprising:
a generation unit that generates a first drawing page on which print data created by an application is drawn and a second drawing page on which drawing data designated to be added onto the print data is drawn;
a transmitting unit that sends the second drawing page subsequent to the first drawing page;
a receiving unit that receives a command to start each of the first and the second drawing pages and a command to end each of the first and the second drawing pages; and
an output control unit that outputs in a manner that the second drawing page is added onto the first drawing page by not executing the command to end the first drawing page and the command to start the second drawing page.

2. The information processing device according to claim 1,
wherein when receiving the command to start the first drawing page from the transmitting unit, the output control unit starts outputting the first drawing page to draw the print data to the first drawing page, and
wherein when receiving the command to end the second drawing page subsequent to the first drawing page, the output control unit draws the drawing data drawn to the second drawing page onto the first drawing page without ending the outputting of the first drawing page, and ends the outputting of the first drawing page after drawing the drawing data.

3. The information processing device according to claim 1,
wherein the information processing device includes a printer driver and a page control unit that controls a process of sending a page of the print data created by the application to the printer driver,
wherein the page control unit includes
the generation unit,
the drawing unit, and
the transmitting unit, and
wherein the printer driver includes
the receiving unit, and
the output control unit.

4. An information processing method comprising:
generating, by a generation unit, a first drawing page on which print data created by an application is drawn and a second drawing page on which drawing data designated to be added onto the print data is drawn;
sending, by a transmitting unit, the second drawing page subsequent to the first drawing page;
receiving, by a receiving unit, a command to start each of the first and the second drawing pages and a command to end each of the first and the second drawing pages; and
outputting, by an output control unit, in a manner that the second drawing page is added onto the first drawing page by not executing the command to end the first drawing page and the command to start the second drawing page.

5. The information processing method according to claim 4,
wherein when receiving the command to start the first drawing page from the transmitting unit, the outputting includes starting outputting the first drawing page to draw the print data to the first drawing page, and
wherein when receiving the command to end the second drawing page subsequent to the first drawing page, the outputting includes drawing the drawing data drawn to the second drawing page onto the first drawing page without ending the outputting of the first drawing page, and ending the outputting of the first drawing page after drawing the drawing data.

6. The information processing method according to claim 4,
wherein the information processing method is executed by an information processing device including a printer driver and a page control unit that controls a process of sending a page of the print data created by the application to the printer driver,
wherein the page control unit includes
the generation unit,
the drawing unit, and
the transmitting unit, and
wherein the printer driver includes
the receiving unit, and
the output control unit.

7. A non-transitory computer-readable recording medium having a program including instructions for causing a computer to function as:
generating, by a generation unit, a first drawing page on which print data created by an application is drawn and a second drawing page on which drawing data designated to be added onto the print data is drawn;
sending, by a transmitting unit, the second drawing page subsequent to the first drawing page;
receiving, by a receiving unit, a command to start each of the first and the second drawing pages and a command to end each of the first and the second drawing pages; and
outputting, by an output control unit, in a manner that the second drawing page is added onto the first drawing page by not executing the command to end the first drawing page and the command to start the second drawing page.
